(19) United States
(12) Patent Application Publication
(10) Pub. No.: US 2005/0084646 A1
(43) Pub. Date: Apr. 21, 2005

(54) Furniture slide for use on hard surface floors

(75) Inventor: Donald V. Edwards, Harrison City, PA (US)

Correspondence Address: JAMES RAY & ASSOCIATES, 2640 PITCAIRN ROAD, MONROEVILLE, PA, 15146, US

(73) Assignee: SIMTEC, CO.

(21) Appl. No.: 10/967,970

(22) Filed: Oct. 19, 2004

Related U.S. Application Data
(60) Provisional application No. 60/513,012, filed on Oct. 21, 2003.

(51) Int. Cl. B32B 3/02

(52) U.S. Cl. 428/95

(57) ABSTRACT

An apparatus for use in the movement of furniture wherein the apparatus is placed between such furniture to be moved and a hard surface floor. The apparatus comprises a first material having a first predetermined configuration and a first predetermined thickness. The first material has a top surface and a bottom surface, the bottom surface having a predetermined texture for contacting such hard surface floor. There is a second material having a second predetermined configuration and a second predetermined thickness and having a bottom surface adhered to the top surface of the first material. The second material being a compressible material and having a top surface for contact with a predetermined portion of such furniture to be moved.

### CROSS REFERENCE TO RELATED APPLICATIONS

This application is closely related to and claims benefit from U.S. Provisional Application Ser. No. 60/513,012 filed on Oct. 21, 2003.

### FIELD OF THE INVENTION

The present invention relates, in general, to an aid for moving furniture and, more, particularly, the present invention relates to a furniture slide for use on hard surface floors.

### BACKGROUND OF THE INVENTION

In both the moving industry and the carpet cleaning industry it is quite common to be faced with the situation in which a relatively large piece of furniture or an appliance has to be moved. With limited manpower it is difficult to pick up the item and carry it to another location.

There have been a variety of prior art devices that have been used to assist in the moving of such furniture or appliance. Most of these devices involve placing the device under the legs of furniture or under the furniture itself in order to slide the furniture across the floor.

One problem that has been encountered with many of the prior art devices is that the furniture can slide off of the device while in the process of sliding the furniture across a floor.

### SUMMARY OF THE INVENTION

The present invention provides an apparatus for use in the movement of furniture wherein the apparatus is placed between such furniture to be moved and a hard surface floor. The apparatus comprises a first material having a first predetermined configuration and a first predetermined thickness. The first material has a top surface and a bottom surface, the bottom surface having a predetermined texture for contacting such hard surface floor. There is a second material having a second predetermined configuration and a second predetermined thickness and having a bottom surface adhered to the top surface of the first material. The second material being a compressible material and having a top surface for contact with a predetermined portion of such furniture to be moved.

Another embodiment of the invention provides an apparatus for use in movement of furniture wherein the apparatus is placed between such furniture to be moved and a hard surface floor. The apparatus comprises a first material having a first predetermined configuration and a first predetermined thickness. The first material having a top surface and a bottom surface, the bottom surface having a predetermined texture for contacting such hard surface floor. There is a reinforcing member which has a second predetermined thickness. The reinforcing member has a bottom surface adhered to the top surface of the first material. There is a second material which has a second predetermined configuration and a third predetermined thickness. The second material has a bottom surface adhered to a top surface of the reinforcing member. The second material being a compressible material has a top surface for contact with a predetermined portion of such furniture to be moved.

Yet another embodiment of the invention provides an apparatus for use in movement of furniture wherein the apparatus is placed between such furniture to be moved and a hard surface floor. The apparatus comprises a first material having a top surface and a bottom surface and a first predetermined configuration adjacent the bottom surface which will come into contact with such hard surface floor and which will provide a predetermined minimum surface contact area in order to minimize friction between the bottom surface and such hard surface floor yet exhibiting a compressive strength which is at least sufficient to support such furniture to be moved. There is also a second material having a second predetermined configuration and a predetermined thickness and having a bottom surface adhered to the top surface of the first material, the second material being a compressible material having a top surface for contact with a predetermined portion of such furniture to be moved.

### OBJECTS OF THE INVENTION

It is, therefore, one of the primary objects of the present invention to provide a furniture slide in which the furniture remains with the slide during movement of the furniture and does not slip off the slide.

Another object of the present invention is to provide a furniture slide in which the slide can operate on hard surface floors.

Still another object of the present invention is to provide a furniture slide in which the slide can be used over and over again.

Yet another object of the invention is to provide a furniture slide in which there is a minimum surface contact area that contacts the hard surface floor area in order to minimize friction between the bottom surface and such hard surface floor yet exhibiting a compressive strength which is at least sufficient to support such furniture to be moved.

Another object of the present invention is to provide a furniture slide in which the material that contacts the furniture to be moved is a compressible material.

In addition to the numerous objects and advantages of the present invention which have been described with some degree of particularity above, it should be both noted and understood that a number of other important objects and advantages of the invention will become more readily apparent to those persons who are skilled in the relevant art of furniture moving from the following more detailed description of the invention, particularly, when such detailed description is taken in conjunction with the appended claims.

### BRIEF DESCRIPTION OF THE DRAWINGS

FIG. 1 is a top or plan view of the furniture slide.

FIG. 2 is a side elevation view of a generally round furniture slide with the compressible material adhered to the top of the slide.

FIG. 3 is bottom view of the furniture slide shown in FIG. 1.

FIG. 4 is a side elevation view of the apparatus according to another embodiment of the invention.

FIG. 5 is a partial perspective view of the apparatus according to an alternate embodiment of the invention.

FIG. 6 is a bottom view of the alternate embodiment of the invention shown in FIG. 5.

FIG. 7 is a side elevation view of the alternate embodiment of the invention shown in FIG. 5.

FIG. 8 is a partial perspective view of the apparatus according to another alternate embodiment of the invention.

FIG. 9 is a bottom view of the alternate embodiment of the invention shown in FIG. 8.

FIG. 10 is a side elevation view of the alternate embodiment of the invention shown in FIG. 8.

FIG. 11 is a partial perspective view of the apparatus according to yet another alternate embodiment of the invention.

FIG. 12 is bottom view of the furniture slide shown in FIG. 1 according to another embodiment of the invention.

FIG. 13 is a cross sectional view taken along the line XIII of the furniture slide shown in FIG. 12.

### BRIEF DESCRIPTION OF THE PRESENTLY PREFERRED AND VARIOUS ALTERNATE EMBODIMENTS OF THE PRESENT INVENTION

Prior to proceeding to the more detailed description of the present invention, it should be noted that for the sake of clarity in understanding the invention, identical components with identical functions have been designated with identical reference numerals throughout the drawing Figures.

Illustrated in the drawing Figures is an apparatus, generally designated 10, for use in the movement of furniture on hard surface floors. Such items of furniture would include virtually all items of furniture including appliances, entertainment centers, bookcases, sofas, desks, dressers, and file cabinets.

The apparatus 10 is placed between such furniture (not shown) to be moved and a hard surface floor. Such hard surface floor would include wood floors, ceramic tile, linoleum, laminate floors, and finished concrete. The apparatus 10 is not for use on unfinished concrete floors or on carpeted floors. The item of furniture would be tilted slightly and an apparatus 10 would be placed under each corner of the furniture to be moved. The item to be moved could then be pushed or pulled to the desired location. It would, thus, require four apparatus 10 units for each item of furniture to be moved, although the same units could be used over and over again.

The apparatus 10 comprises a first material 2 which has a first predetermined configuration and a first predetermined thickness. The first material has a top surface 4 and a bottom surface 6. The bottom surface 6 is has a predetermined texture for contacting such hard surface floor.

There is a second material 8 that has a bottom surface 12 adhered to the top surface 4 of such first material 2. Such second material 8 has a second predetermined configuration and has a second predetermined thickness. The second material 8 is a compressible material that has a top surface 14 for contacting such furniture to be moved.

Such second material 8 is an elastomeric material that is selected from a group that includes natural rubber, synthetic rubber, polyurethane, ethylene vinyl acetate and various combinations thereof. It is presently preferred that such second material 8 is ethylene vinyl acetate. The second material 8 being compressible conforms to any item that is placed on it. Thus, the second material grips the item being moved and stays with that item so as to substantially prevent the item from slipping off of the apparatus 10.

Such first material 2 is selected from a group including felt, tufted carpet, woven fabric material and various combinations thereof. In a preferred embodiment of the invention such first material 2 is felt. The felt bottom surface 6 of such first material 2 glides on the hard surface floor without any difficulty. Again, the apparatus 10 (furniture slide) slides freely on the hard surface floor for which the furniture slide is intended. As stated previously such apparatus is not for use on rough floors such as unfinished concrete as the rough texture would cause damage to the first material 2.

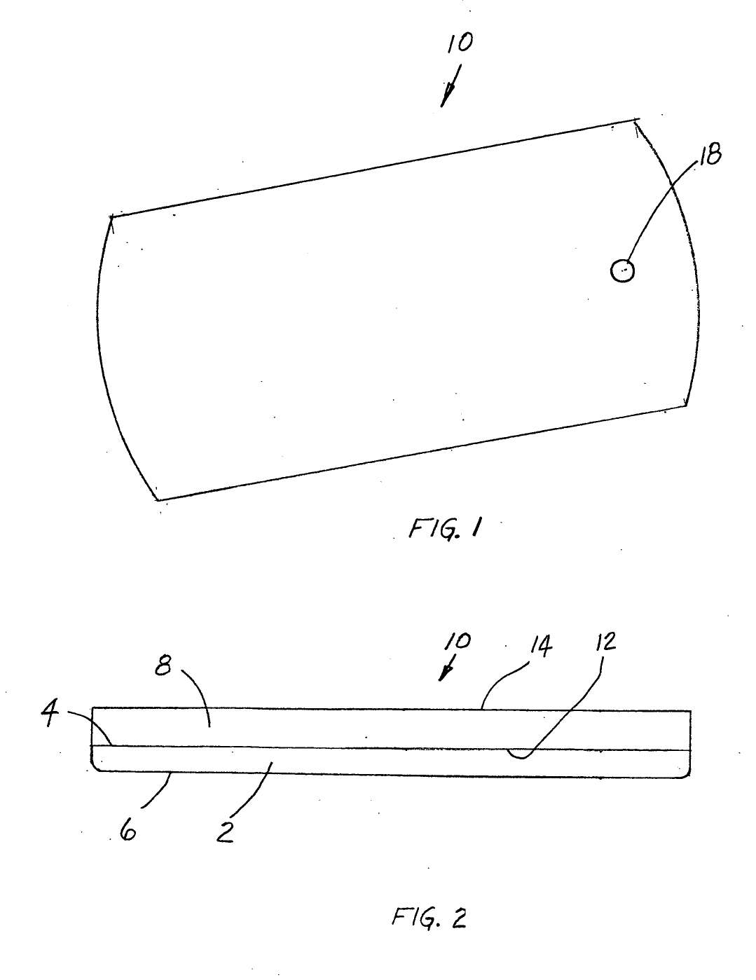

It is presently preferred that the first predetermined configuration of the first material 2 of the apparatus 10 be a substantially rectangular shape with each end on the width portion having a substantially convex shape as is seen in FIG. 1. It is also presently preferred that such second configuration be substantially identical to the first predetermined configuration. It is, further, another embodiment of the invention that such substantially rectangular shape have a length of between about 2 and about 9 inches and a width of between about 2 and about 6 inches. Thus, it is possible for a unit to be used for moving furniture that is essentially a 2 inch by 2 inch square. However, it is presently preferred that such substantially rectangular shape have a length of between about 7 and about 8 inches and a width of between 4 and about 5 inches. It is most preferred that such length be about 8 inches and such width be about 5 inches.

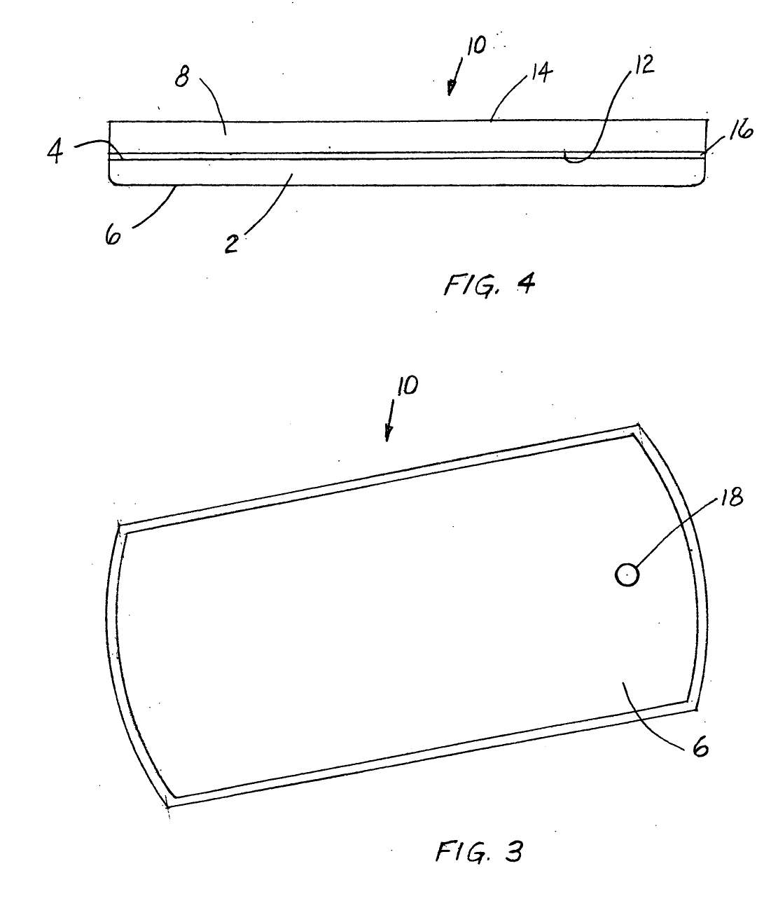

It is also presently preferred that such outer edges of such bottom surface 6 of such first material 2 be slightly arcuate to assist in sliding over any unforeseen impediment. This arcuate shape is readily seen in FIG. 3. It is also presently preferred that such second predetermined thickness be greater than such first predetermined thickness.

It is another embodiment of the invention that such apparatus 10 incorporate an aperture 18, formed into the apparatus 10 closely adjacent one of the convex ends. As has been described previously, four units of the apparatus 10 are used in moving an item of furniture. Such units can be used many times. Therefore, another embodiment of the invention provides a tie that passes through such aperture 18 in each of the four units of apparatus 10 so as to hold the units together for storage purposes.

In an alternate embodiment of the invention such apparatus 10 retains the substantially rectangular shape but has a length of between about 4 and about 6 feet and a width of between about 4 and about 10 inches. In this embodiment such apparatus 10 is placed under one side of such furniture to be moved instead of each corner and another apparatus 10 is placed on an opposite side of such furniture. Thus, this embodiment encompasses the use of two units of such apparatus 10 instead of four units as is used in the other embodiment.

In yet another alternate embodiment of the invention such first and such second predetermined configurations have a substantially round shape.

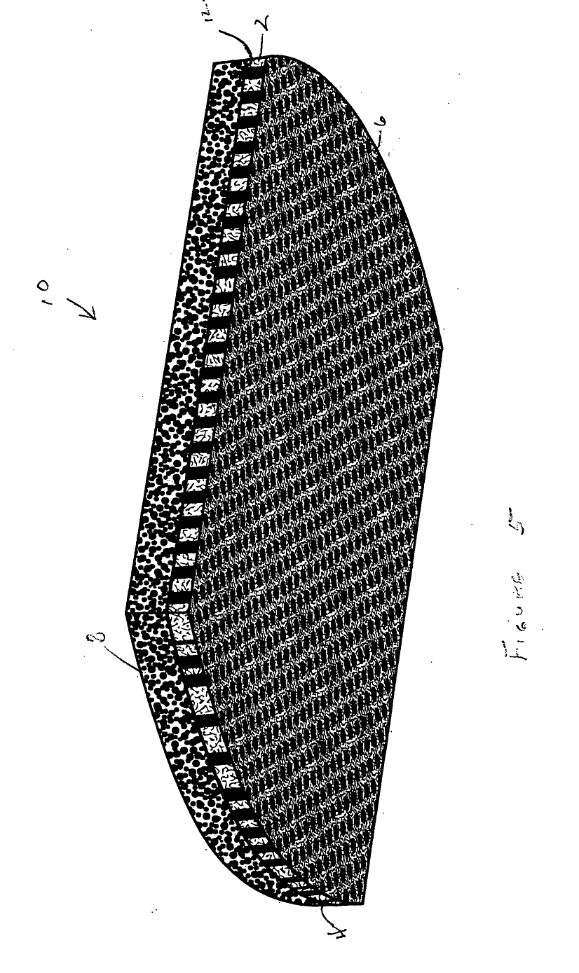

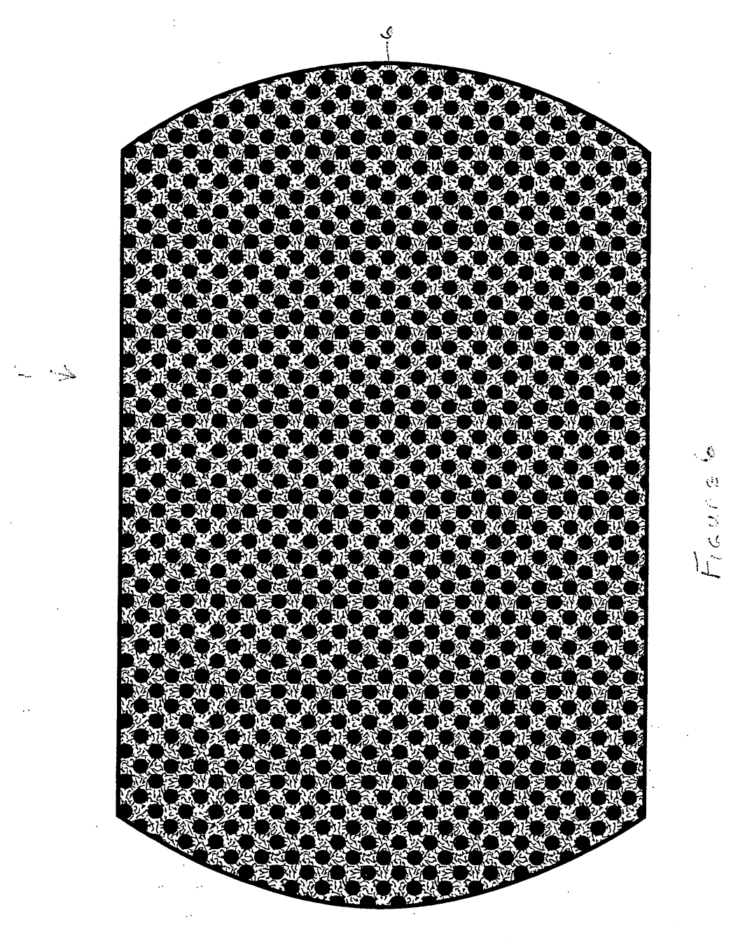

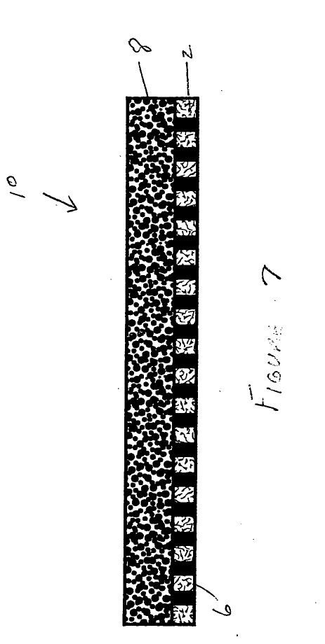

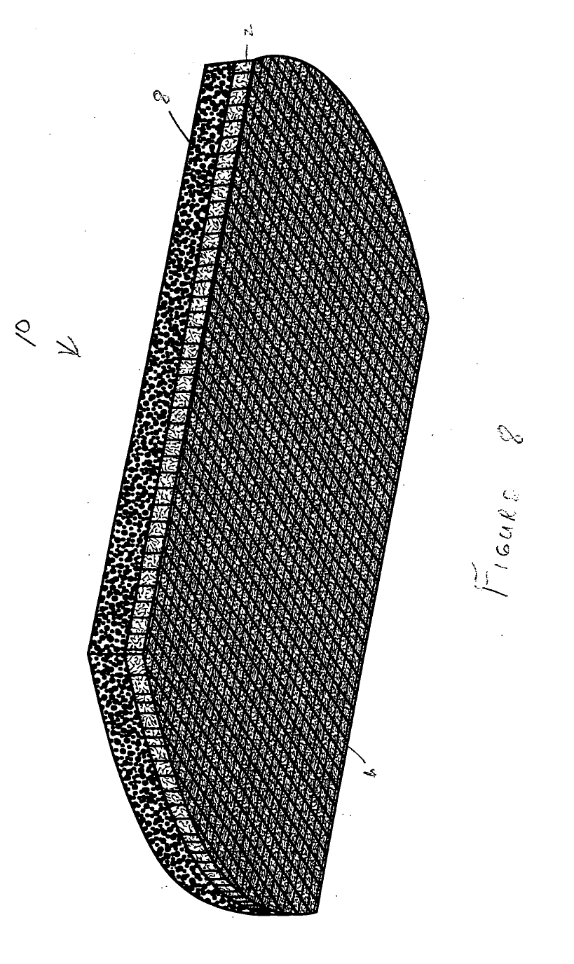

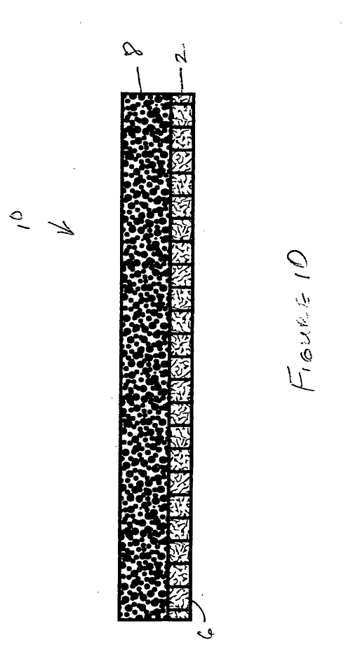

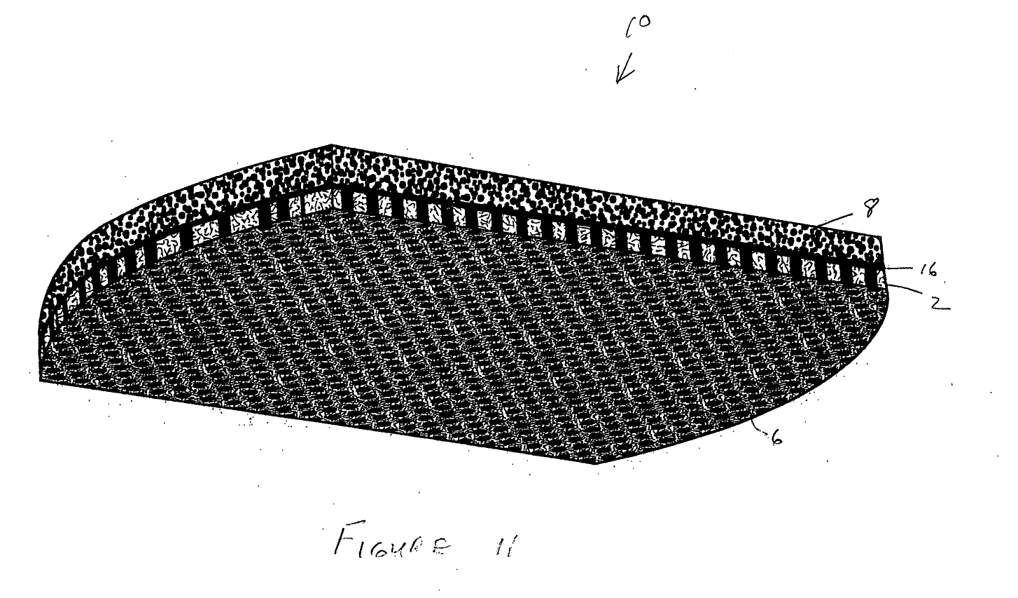

Reference is now made to FIGS. 4 and 11, illustrated therein is an alternate embodiment of the invention in which a reinforcing layer 16 is bonded to the top surface 4 of the first material 2 and to the bottom surface 12 of such second material 8 to give the apparatus 10 additional strength. It is presently preferred that such reinforcing layer be made of plastic. Reference is now made to FIGS. 5-10 and 12-13, illustrated therein are other embodiments of the invention. In these embodiments such first material 2 has a minimal surface area 6 for contacting such hard surface floor while exhibiting a compressive strength which is at least sufficient to support such furniture to be moved.

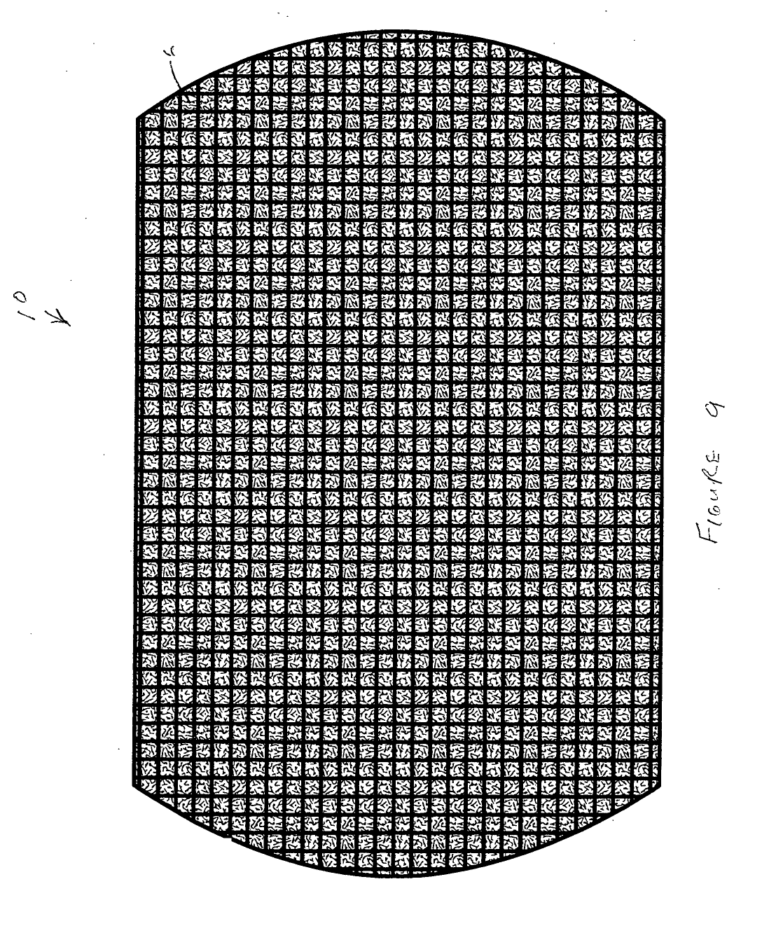

In one embodiment the minimum surface area is achieved by having voids disposed in a substantially uniform manner throughout the first material 2. The reduction in surface area that contacts the hard surface floor makes it easier to move the item being moved by reducing the friction between the furniture slide and the floor. The mode of the voids can be achieved in a variety of means. FIGS. 5, 6, and 7 show one mode wherein the voids are substantially round. FIGS. 8, 9 and 10 show an alternate mode wherein the voids are substantially rectangular leaving the bottom surface with a plurality of substantially rectangular or square projections for contacting the hard surface floor.

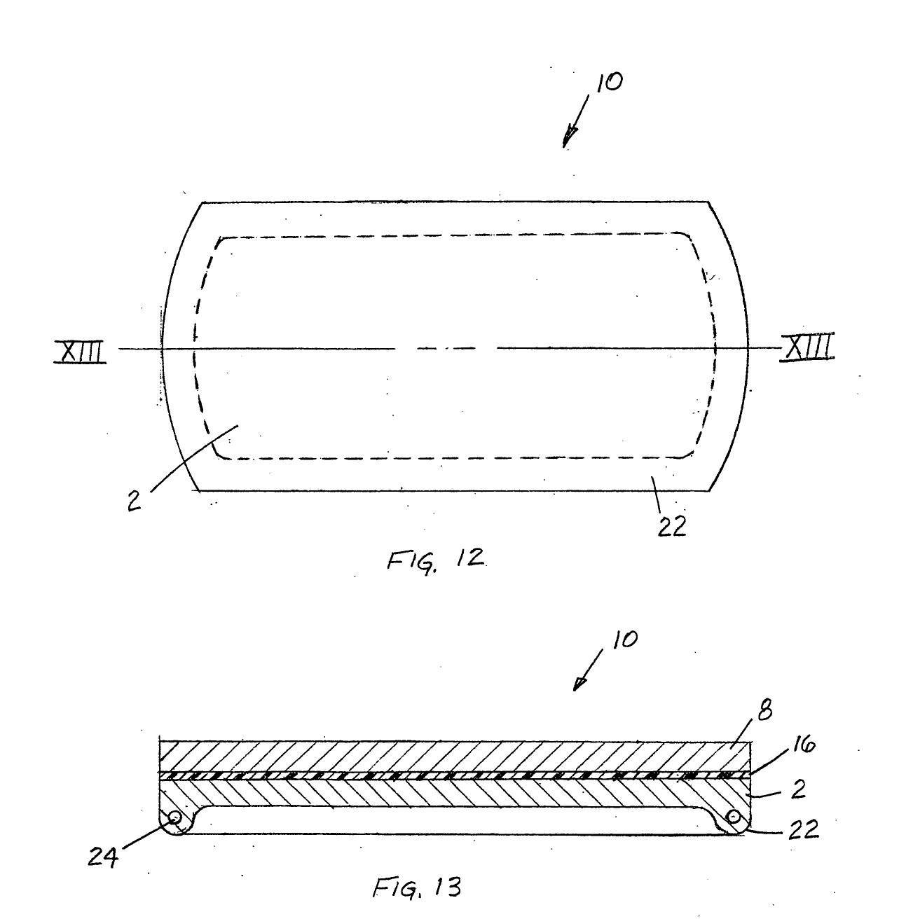

Illustrated in FIGS. 12 and 13 is yet another embodiment of the invention wherein such first material 2 has a raised beadlike member 22 which projects from the bottom surface 6 of such first material 2 closely adjacent the outer edge of the bottom surface 6. It is presently preferred that such raised beadlike member 22 have a reinforcing member 24 disposed in an inner portion of such beadlike member 22. It is presently preferred that such reinforcing member 24 be disposed in such beadlike member 22 closely adjacent where such beadlike member projects from such bottom surface 6 of such first material 2. It is also preferred that such reinforcing member be plastic. It is also an embodiment of the invention that such furniture slide as shown in FIGS. 12 and 13 have a plastic reinforcing member between the first material 2 and such second material 8 as is shown in FIG. 13.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

1. An apparatus for use in movement of furniture wherein said apparatus is placed between such furniture to be moved and a hard surface floor, said apparatus comprising;
(a) a first material having a first predetermined configuration and a first predetermined thickness, said first material having a top surface and a bottom surface, said bottom surface having a predetermined texture for contacting such hard surface floor; and
(b) a second material having a second predetermined configuration and a second predetermined thickness and having a bottom surface adhered to said top surface of said first material, said second material being a compressible material having a top surface for contact with a predetermined portion of such furniture to be moved.

2. The apparatus, according to claim 1, wherein said first material is selected from a group including felt, carpet, woven fabric and various combinations thereof.

3. The apparatus, according to claim 2, wherein said first material is felt.

4. The apparatus, according to claim 1, wherein said second material is an elastomeric material.

5. The apparatus, according to claim 4, wherein said elastomeric material is selected from a group including natural rubber, synthetic rubber, polyurethane, ethylene vinyl acetate and various combinations thereof.

6. The apparatus, according to claim 5, wherein said elastomeric material is ethylene vinyl acetate.

7. The apparatus, according to claim 1, wherein said bottom surface of said first material has a predetermined contour.

8. The apparatus, according to claim 7, wherein said predetermined contour of said bottom surface is substantially flat.

9. The apparatus, according to claim 7, wherein outer edges of said bottom surface of said first material have an upwardly extending arcuate shape.

10. The apparatus, according to claim 1, wherein said first predetermined configuration is generally rectangular.

11. The apparatus, according to claim 10, wherein each end of said generally rectangular first predetermined configuration on a width portion thereof has a substantially convex shape.

12. The apparatus, according to claim 10, wherein said generally rectangular first predetermined configuration has a length of between about 7 and about 8 inches and a width of between about 4 and about 5 inches.

13. The apparatus, according to claim 10, wherein said generally rectangular first predetermined configuration has a length of between about 4 feet and about 6 feet and a width of between about 4 inches and about 10 inches.

14. The apparatus, according to claim 11, wherein said first predetermined configuration and said second predetermined configuration are substantially identical in a horizontal plane.

15. The apparatus, according to claim 11, wherein said apparatus further includes an aperture formed in said apparatus closely adjacent at least one of said each end having said substantially convex shape.

16. The apparatus, according to claim 1, wherein said first predetermined configuration and said second predetermined configuration is substantially round.

17. The apparatus, according to claim 1, wherein said second predetermined thickness is greater than said first predetermined thickness.

18. An apparatus for use in movement of furniture wherein said apparatus is placed between such furniture to be moved and a hard surface floor, said apparatus comprising;
(a) a first material having a first predetermined configuration and a first predetermined thickness, said first material having a top surface and a bottom surface, said bottom surface having a predetermined texture for contacting such hard surface floor;
(b) a reinforcing member having a second predetermined configuration and a second predetermined thickness and having a bottom surface adhered to said top surface of said first material; and
(c) a second material having a third predetermined configuration and a third predetermined thickness and having a bottom surface adhered to a top surface of said reinforcing member, said second material being a compressible material having a top surface for contact with a predetermined portion of such furniture to be moved.

19. The apparatus, according to claim 18, wherein said reinforcing member is plastic.

20. The apparatus, according to claim 18, wherein said second material is an elastomeric material.

21. The apparatus, according to claim 20, wherein said elastomeric material is selected from a group including natural rubber, synthetic rubber, polyurethane, ethylene vinyl acetate and various combinations thereof.

22. The apparatus, according to claim 20, wherein said elastomeric material is ethylene vinyl acetate.

23. The apparatus, according to claim 18, wherein said first material is felt.

24. The apparatus, according to claim 18, wherein said first predetermined configuration, said second predetermined configuration and said third predetermined configuration are substantially identical.

25. An apparatus for use in movement of furniture wherein said apparatus is placed between such furniture to be moved and a hard surface floor, said apparatus comprising;
(a) a first material having a top surface and a bottom surface and a first predetermined configuration adjacent said bottom surface which will come into contact with such hard surface floor and which will provide a predetermined minimum surface contact area in order to minimize friction between said bottom surface and such hard surface floor yet exhibiting a compressive strength which is at least sufficient to support such furniture to be moved; and
(b) a second material having a second predetermined configuration and a predetermined thickness and having a bottom surface adhered to said top surface of said first material, said second material being a compressible material having a top surface for contact with a predetermined portion of such furniture to be moved.

26. The apparatus, according to claim 25, wherein said first predetermined configuration adjacent said bottom surface which will come into contact with such hard surface floor and which will provide a predetermined minimum surface contact area includes a predetermined plurality of voids having a third predetermined configuration disposed at least adjacent said bottom surface.

27. The apparatus, according to claim 26, wherein said third predetermined configuration of said plurality of voids is substantially round.

28. The apparatus, according to claim 26, wherein said third predetermined configuration of said plurality of voids is substantially rectangular.

29. The apparatus, according to claim 25, wherein said first predetermined configuration adjacent said bottom surface which will come into contact with such hard surface floor and which will provide a predetermined minimum surface contact area includes a raised beadlike member extending outwardly from said bottom surface closely adjacent an outer edge of said bottom surface of said first material.

30. The apparatus, according to claim 29, wherein said raised beadlike member further includes a reinforcing member disposed in an inner portion of said beadlike member.

31. The apparatus, according to claim 29, wherein said apparatus further includes a reinforcing member having a third predetermined thickness disposed between said top surface of said first material and said bottom surface of said second material.
